(19) United States
(12) Patent Application Publication
(10) Pub. No.: US 2008/0031513 A1
(43) Pub. Date: Feb. 7, 2008

(54) Method and system for high resolution, ultra fast 3-D imaging

(75) Inventor: Douglas P. Hart, Charlestown, MA (US)

Correspondence Address: WOLF GREENFIELD & SACKS, P.C., 600 ATLANTIC AVENUE, BOSTON, MA, 02210-2206, US

(73) Assignee: Massachusetts Institute of Technology, Cambridge, MA (US)

(21) Appl. No.: 11/725,585

(22) Filed: Mar. 19, 2007

Related U.S. Application Data
(63) Continuation of application No. 09/616,606, filed on Jul. 14, 2000, now abandoned.

(51) Int. Cl. G06K 9/00

(52) U.S. Cl. 382/154

(57) ABSTRACT

A high-speed three-dimensional imaging system includes a single lens camera subsystem with an active imaging element and CCD element, and a correlation processing subsystem. The active imaging element can be a rotating aperture which allows adjustable non-equilateral spacing between defocused images to achieve greater depth of field and higher sub-pixel displacement accuracy. A speckle pattern is projected onto an object and images of the resulting pattern are acquired from multiple angles. The images are locally cross-correlated using a sparse array image correlation technique and the surface is resolved by using relative camera position information to calculate the three-dimensional coordinates of each locally correlated region. Increased resolution and accuracy are provided by recursively correlating the images down to the level of individual points of light and using the Gaussian nature of the projected speckle pattern to determine subpixel displacement between images. Processing is done at very high-speeds by compressing the images before they are correlated. Correlation errors are eliminated during processing by a technique based on the multiplication of correlation table elements from one or more adjacent regions.

### RELATED APPLICATIONS

This application is a continuation (CON) of U.S. Ser. No. 09/616,606, entitled “METHOD AND SYSTEM FOR HIGH RESOLUTION, ULTRA FAST 3-D IMAGING, filed on Jul. 14, 2000, which is herein incorporated by reference in its entirety.

### BACKGROUND OF THE INVENTION

Devices which rely on machine vision such as robotic and manufacturing equipment, image based measurement equipment, topographical mapping equipment, and image recognition systems often use correlation of a single image (auto-correlation) or correlation between multiple images (cross-correlation) to establish the size, shape, speed, acceleration and/or position of one or more objects within a field of view.

Image correlation is typically performed using Fast Fourier Transforms (FFTs), image shifting, or optical transformation techniques. These techniques, although accurate, require extensive processing of the images in hardware or software. For an image having N×N pixels, for example, FFT techniques require on the order of N² log N iterations while image shifting techniques require Δ² N² iterations, where Δ is the length of the correlation search in pixels. With either of these techniques, the image or a subsection of the image is fully (i.e. 100%) correlated regardless of the usefulness of the information content.

The optical transformation technique relies on the optical construction of the Young's fringes formed when a coherent light is passed through the image and then through Fourier transform optics. The resulting fringe pattern is digitized and analyzed by a computer. This is certainly the most elegant of the three methods and potentially the fastest. In practice, however, it has been found that it is difficult to detect the orientation of the Young's fringes.

Optical 3-D measurement techniques can be found in applications ranging from manufacturing to entertainment. One approach uses a stereoscopic system where the camera separation can be adjusted relative to the desired measured depth information. Another approach is the well-known BIRIS range sensor which includes a circular mask for determining 3-D information from multi-exposure images. Although numerous methods are available for quantitative depth measurement, there is a need for an inexpensive, fast, and robust 3-D imaging system.

### SUMMARY OF THE INVENTION

The present method and apparatus is based on projecting a speckle pattern onto an object and imaging the resulting pattern from multiple angles. The images are locally cross-correlated and the surface is resolved by using relative camera position information to calculate the three-dimensional coordinates of each locally correlated region. Increased resolution and accuracy can be achieved by recursively correlating the images down to the level of individual points of light and using the Gaussian nature of the projected speckle pattern to determine subpixel displacement between images. Processing can be done at very high-speeds by compressing the images before they are correlated.

Accordingly, a high-speed three-dimensional imaging system, based on projecting light onto an object and imaging the reflected light from multiple angles, includes a single lens camera subsystem with an active imaging element and CCD element, and a correlation processing subsystem. The active imaging element can be a rotating aperture which allows adjustable non-equilateral spacing between defocused images to achieve greater depth of field and higher sub-pixel displacement accuracy.

The correlation processing subsystem achieves high resolution, ultra fast processing. This processing can include recursively correlating image pairs down to diffraction limited image size of the optics. Correlation errors are eliminated during processing by a technique based on the multiplication of correlation table elements from one or more adjacent regions. Processing is accomplished by compressing the images into a sparse array format before they are correlated.

In an embodiment, the projected light is a projected random speckle pattern. The Gaussian nature of the projected pattern is used to reveal image disparity to sub-pixel accuracy.

The present system and method circumvent many of the inherent limitations of multi-camera systems that use fast Fourier transform (FFT) spectral based correlation. Another advantage of the present approach is that it uses a single optical axis resulting in very simple aligning procedures. Problems associated with the motion (vibration) of cameras with respect to each other that are found in stereoscopic techniques and that would otherwise produce erroneous results are also eliminated.

The present method and apparatus can be used for such applications as near real-time parts inspection, surface mapping, bio-measurement, object recognition, and part duplication, and makes feasible a myriad of technologies that are currently hindered by the inability to resolve three-dimensional information at high rates.

### BRIEF DESCRIPTION OF THE DRAWINGS

FIG. 1 illustrates an embodiment of a 3-D imaging system.

FIG. 2A illustrates a rotating offset aperture for use in the system of FIG. 1.

FIG. 2B is a diagram of a rotation mechanism for the aperture of FIG. 2A.

FIG. 3 schematically illustrates a single lens camera with the offset rotating aperture of FIG. 2A.

FIGS. 4A to 4C illustrate the influence of optical parameters on image disparity for the system of FIG. 1.

FIG. 5 illustrates a process for three-dimensional imaging using the system of FIG. 1.

FIG. 6 illustrates correlation error correction.

FIGS. 7A, 7B show respective bias and rms errors of detecting correlation peak center using synthetic speckle images and sub-image cross-correlation.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

The present system uses image correlation which provides ultra fast and super high resolution image processing. The image processing includes a technique referred to as sparse array image correlation. Although this processing offers several advantages on multi-exposed single frame images, it is particularly suitable for processing single exposed image frames. The system includes a single lens, single camera subsystem that in an embodiment uses a rotating off-axis aperture for sampling defocused images and generating single exposed frames with depth related image disparity between them.

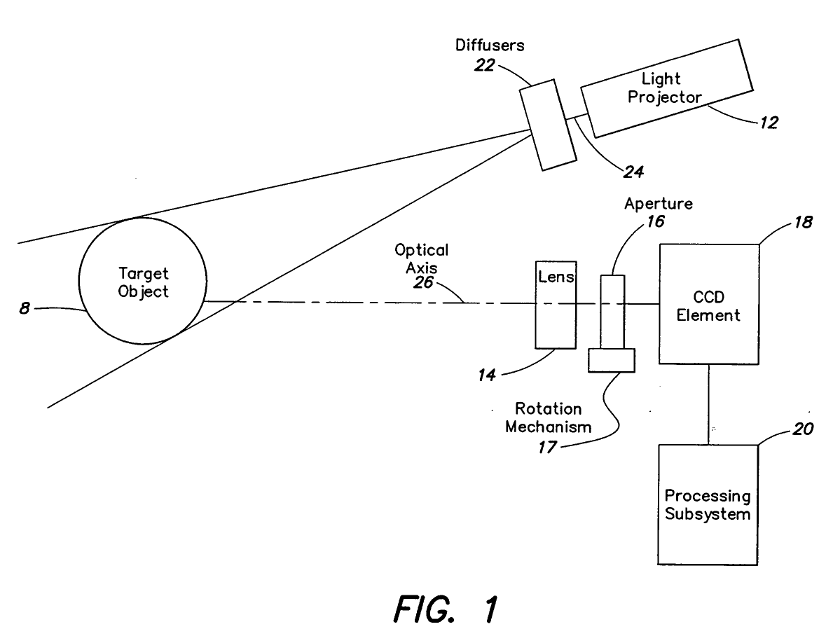

FIG. 1 illustrates an embodiment of a 3-D imaging system which includes a light projector 12, a camera subsystem that codes three-dimensional position information into two-dimensional images using a lens 14, a rotating aperture 16, rotation mechanism 17 and a CCD element 18 aligned along an optical axis 26. The imaging system further includes a correlation processing subsystem 20 that is connected to the CCD element.

The light projector 12, which generates a random pattern on what otherwise can be featureless 3-D objects, includes an illumination source such as a Uniphase Novette™ 0.5 mW HeNe (λ=633 nm) laser. Two light shaping diffusers 22 (one with 5 degrees and the other with 10 degrees of diffuser angle) separated by approximately 40 mm expand the laser beam 24 and create a fine speckle pattern for projection onto the target object 8. It should be noted that the principles of the present method and system apply also to configurations that use white light illumination, infrared illumination or other non-diffused light rather than a projected speckle pattern.

The correlation processing subsystem 20 can be implemented in a programmed general purpose computer. In other embodiments, the processing subsystem 20 can implemented in nonprogrammable hardware designed specifically to perform the processing functions disclosed herein.

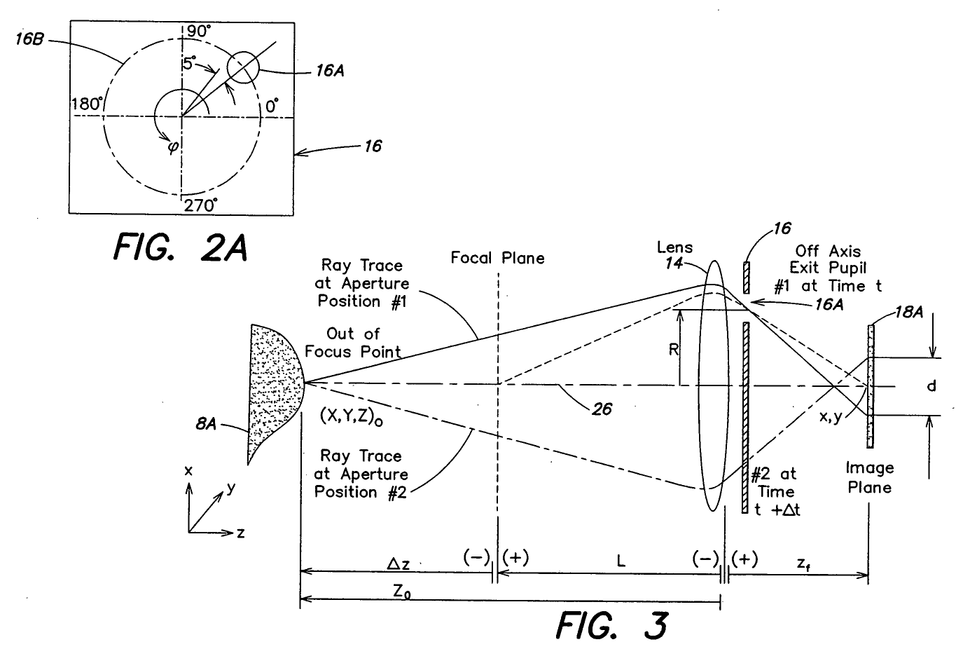

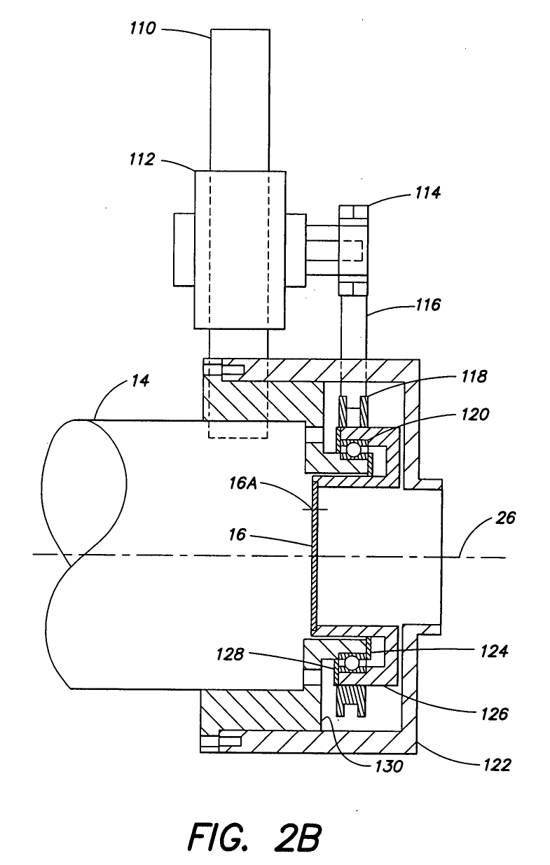

As shown in FIG. 2A, an off-axis exit pupil 16A samples the blurred image of any out-of-focus point that results in a circular image movement as the aperture rotates along a circle 16B around the optical axis 26 of the camera. An embodiment of the rotation mechanism 17 is shown in FIG. 2B and includes a stepper motor 112 coupled through a gear or belt drive 116 which in operation provides the rotation of the aperture 16 through an angle denoted φ in FIG. 2A. The rotation mechanism 17 further includes a motor plate 110, motor pulley 114, pulley 118 and bearing 120. An aperture housing 126 and retainer rings 124, 128 hold the aperture disk 16 in position in stationary housing (C-mount) 122 along optical axis 26. The lens 14 is mounted to the housing 122 via lens mount 130.

The aperture movement makes it possible to record on the CCD element 18 a single exposed image at different aperture locations with application of localized cross-correlation to reveal image disparity between image frames. There are several advantages to using cross-correlation rather than auto-correlation: reduced noise level, detection of zero displacement (in-focus points) and the absence of directional ambiguity, all of which are major problems of auto-correlation based processing. These advantages make higher signal-to-noise ratio, higher spatial and depth resolution, and lower uncertainty feasible, as described further below.

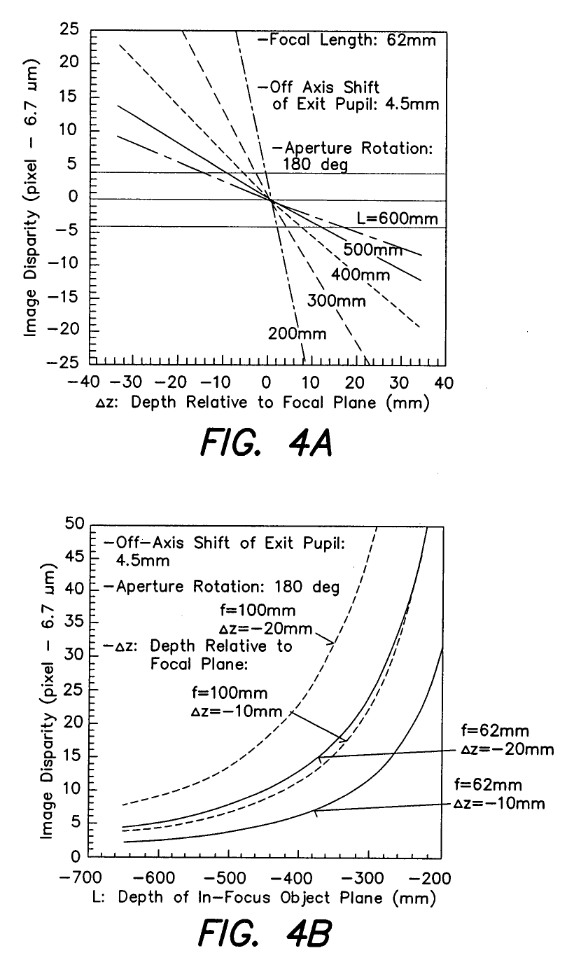

In the imaging system of FIG. 1, quantitative 3-D object coordinates are identified by using the same principle as that of the BIRIS range sensor or the Defocusing Digital PIV camera disclosed in C. E. Willert and M. Gharib, “Three-dimensional particle imaging with a single camera”, Experiments in Fluids 12, pp. 353-358, 1992. FIG. 3 schematically illustrates the single lens camera with the off-axis rotating aperture 16. As can be seen, at least two image recordings on the image plane 18A at different angles of rotation of the aperture 16 are used to generate the measured displacement for the random pattern. The separate images are captured successively as the aperture rotates to position #1 at time t and position #2 at time t+Δt. Note that Δt is generally negligible in relation to possible movement of the target object 8.

The rotation center of the image gives the proper in-plane object coordinates,

$$\begin{matrix}{X}_{O} = \frac{- {xZ}_{O} ( L - f )}{fL} & ( 1 a ) \\ {Y}_{O} = \frac{- {yZ}_{O} ( L - f )}{fL} & ( 1 b )\end{matrix}$$

where Xₒ,Yₒ are the in-plane object coordinates, f is the focal length of the camera objective, L is the depth of in-focus object points (focal plane), R is the radius of the circle along which the exit pupil is rotating, and d is the diameter of a circle along which the relevant out-of-focus point is moving on the image plane 18A as the aperture is rotated. The magnitude of the pattern movement represents the depth information (Zₒ) measured from the lens plane. Zₒ can be evaluated from two Gaussian lens laws for in-focus and out-of-focus object points and by using similar triangles at the image side,

$${Z}_{O} = \frac{1}{L} + \frac{d ( L - f )}{2 RfL} \qquad ( 1 c )$$

The signal-to-noise ratio, relative error, and accuracy of detecting image pattern movement by cross-correlation is influenced by the magnitude of the displacement vector being measured. For example, there is a trade-off between maximum detectable disparity and spatial resolution. This influence can be reduced and hence the dynamic range of displacement detection can be significantly improved by taking more than two images in non-equilateral aperture spacing. In order to remove possible ambiguity of image center detection, the rotation between the first and the third image is preferably 180 degrees while the intermediate recording can be adjusted according to the actual object depth.

The depth resolution of the present 3-D imaging system depends on the optical parameters and on the uncertainty of detecting image disparity, which is related to the correlation processing algorithm. The minimum resolvable disparity is given by the rms error of locating the center of the correlation peak by sub-pixel accuracy. As a first approximation this error can be related to the average speckle diameter for the projected pattern, based on the fact that the rms error is higher at larger speckle size:
σ_{d}=c_{τ}d_{τ} (2)
where d_{τ} is the average speckle size and c_{τ}is a constant that depends on the correlation processing. Typical values for c_{τ}are in the range of 1-10% and the optimal speckle size is around 2 pixels. Taking this relation into consideration, the rms error in depth detection and hence the minimum resolvable depth is given by combining (1c) and (2), as follows:

$${σ}_{Z} = \vert {( \frac{1}{L} + {c}_{τ} {d}_{τ} \frac{L - f}{2 RfL} )}^{- 1} \vert \qquad ( 3 )$$

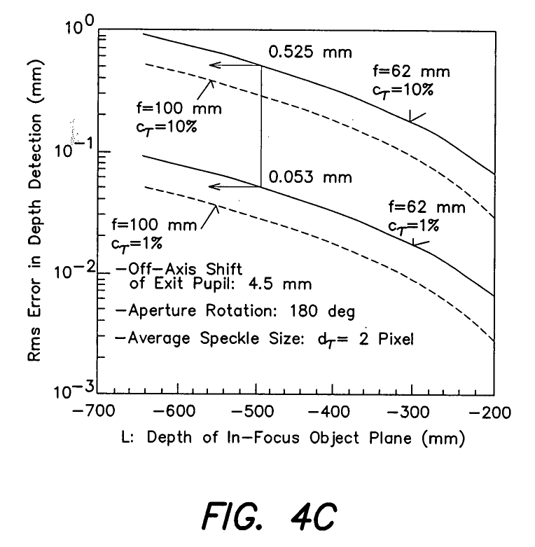

FIGS. 4A to 4C provide information on the influence of optical parameters on image disparity. FIG. 4A shows the depth relative to focal plane versus image disparity. FIG. 4B shows depth of in-focus object plane versus image disparity. FIG. 4C shows the estimated depth resolution at 62 mm and at 100 mm focal lengths as the object is moved towards the camera. It is interesting to note that enhancement in depth resolution achieved by increasing the off-axis shift of the exit pupil can also be realized by improved accuracy of processing (i.e., lower c_{τ}) or by reduced speckle size. The latter is generally limited by sampling on the CCD array and also by a related uncertainty in fractional image disparity approximation. As can be seen, there is no directional ambiguity in the measured depth that is shown by the approximately 180-degree of phase shift between out-of-focus points in front or behind the focal plane. In an embodiment, the depth resolution at 500 mm object distance and 100 mm object diameter is estimated to be around 0.053˜0.5 mm, depending on the accuracy of the processing algorithm.

The above-noted relationship between depth and image disparity assumes an aberration-free optical system in which the optical path difference of the rays at different aperture positions does not influence the resulting image. This makes a diffraction limited optical system necessary that also allows the application of the Gaussian Point Spread Function (PSF) approximation. Hence, sub-pixel resolution and higher dynamic range in displacement detection become possible.

In an embodiment, the lens 14 is a diffraction limited monochromatic camera objective that provides aberration-free imaging at each aperture position. In order to keep the system as flexible as possible, a modular structure of lens, aperture, and CCD camera can be configured. In the configuration shown in FIG. 1, the rotating aperture 16 is placed in between the CCD element 18 and the lens 14. Although this positioning may not be optimal regarding the performance of the lenses, it does allow for a smaller rotation mechanism 17 to be built around the lens. A long back focal length ensures enough space between the camera and the lens for the rotation mechanism. In an embodiment, off-the-shelf stock lenses are configured in a simple split triplet design, though other lens configurations are also possible.

In an alternate embodiment, the aperture element comprises three optical shutters (e.g., ferroelectric liquid crystal optical shutters) offset from the optical axis and the camera subsystem further includes switching means for sequentially switching on the optical shutters such that three images are acquired sequentially from different angles.

As noted above, ultra fast processing, based on localized sub-image correlation, is used to reveal depth related disparity between two or more single exposed, single frame images. A high processing speed (e.g., 16,000 independent disparity vectors per sec) is made possible utilizing the bimodal structure of the recorded random speckle pattern combined with an efficient data encryption and sparse array correlation technique. The trade-off between sub-image window size and spatial resolution of depth measurement can be eliminated by using a recursive algorithm, which includes a novel correlation error correction as described further herein.

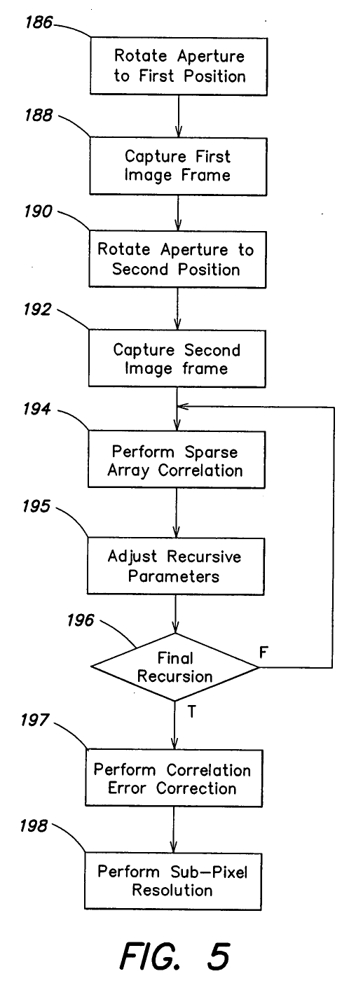

FIG. 5 illustrates a process for three-dimensional imaging using the system of FIG. 1. The process shown is for the case in which two image frames are acquired. At 186, the aperture is rotated such that the opening or exit pupil 16A (FIG. 2A) is at a first position offset from the optical axis (FIG. 3). A first image frame is captured at 188 using the aperture at the first position. Likewise at 190 and 192, a second image frame is captured with the aperture rotated through an angle φ (FIG. 2A) such that the opening or exit pupil is at a second offset position. Once the frames are captured, the processing subsystem 20 (FIG. 1) performs several techniques to correlate the information contained in the image frames. At 194, the processing subsystem performs sparse array cross-correlation. A recursive technique described further below is performed at 195, 196. At 197, correlation error correction is performed to improve the correlation result. At 198, a sub-pixel resolution process is performed. Each of these processing steps is described further herein. The surface of the target object is resolved by using relative camera position information to calculate the three-dimensional coordinates of each locally correlated region.

High-resolution processing is achieved by using a recursive correlation technique in which a region is first correlated, then the interrogation window size is reduced and offset by the previous result before re-correlating with the new window over a reduced region. After each correlation, the compression ratio is reduced such that there is no compression of the image during the final correlation. This processing assures that all available data is used to resolve sub-pixel accuracy.

The sparse array image correlation approach is disclosed in U.S. Pat. No. 5,850,485 issued Dec. 15, 1998, the entire contents of which are incorporated herein by reference. Sparse array image correlation is based on the sparse format of image data—a format well suited to the storage of highly segmented images. It utilizes an image compression method that retains pixel values in high intensity gradient areas while eliminating low information background regions. The remaining pixels are stored in sparse format along with their relative locations encoded into 32 bit words. The result is a highly reduced image data set that retains the original correlation information of the image. Compression ratios of 30:1 using this method are typical. As a result, far fewer memory calls and data entry comparisons are required. In addition, by utilizing an error correlation function, pixel comparisons are made through single integer calculations which eliminates time consuming multiplication and floating point arithmetic. Thus, sparse array image correlation typically results in much higher correlation speeds and lower memory requirements than spectral and image shifting correlation algorithms.

The first step in sparse array image correlation is to generate a data array that contains enough information to determine the displacement of particles in a speckle image or between two images in the case of cross-correlation. In order to facilitate processing, it is desired to retain the minimum amount of data to obtain a specified resolution in the final results. Unfortunately, it is difficult to determine a priori the exact information that is needed to achieve this. However, it can be shown, from the well-known statistical correlation function that pixels with high intensity contribute more to the overall value of the correlation coefficient than pixels of low intensity. This characteristic of the statistical correlation function adversely affects the ability to determine the subpixel displacement of points of light in a speckle image by unduly weighting the significance of high-intensity pixels.

Much of the information contained in a speckle image that allows sub-pixel resolution of tracer particle movement resides in the intensity of pixels representing the edges of the particle images. It is not the level of pixel intensity in a speckle that allows the displacements to be determined through correlation. Rather, it is the relative change in intensity between the background and the tracer particle images that makes this possible. In much the same way two blank pieces of paper are aligned on a desk, image correlation relies on the change in intensity around the edges of the objects being aligned and not the featureless, low intensity gradient, regions. Thus, in principle, all pixels in low intensity gradient regions can be eliminated from a speckle image with only a slight loss in correlation information as long as the relative positions and intensities of the remaining pixels are maintained. Except for a small number of pixels representing tracer particles, speckle images are predominantly blank. Therefore, the data size necessary to determine tracer particle movement within speckle images can be significantly reduced with little or no loss in accuracy. This is the basis by which sparse array correlation works. Eliminating pixels that have little effect on the determination of tracer particle movement reduces the data set representing a speckle image. The remaining pixel intensities are recorded in sparse format along with their relative positions.

Speckle images are strongly bimodal, composed of light points on a dark background. It is, therefore, relatively easy to eliminate low intensity, background pixels from the data. The simplest technique to accomplish this is to set a threshold level and retain only those pixels with intensities above the threshold. A relatively robust and accurate technique for setting the appropriate threshold level is to perform a histogram concavity analysis. A simpler and somewhat faster technique is to generate an intensity distribution curve that indicates the number of pixels with intensities above a specified level. Since the curve is an accumulation of pixel numbers, it is piecewise smooth, at least to the resolution of the CCD camera and thus, it is a simple matter to select a threshold level that corresponds to a specific slope on the curve. This technique is not as robust or accurate as the histogram concavity analysis; however, since the pixel intensities in speckle images are so strongly bimodal, the precise threshold level is often not critical.

Significant image compression can be achieved by the gradient method of segmentation. Local intensity gradients can be approximated as:
|VI|≈|I_{(i+1, j)}−I_{(i,j)}|+|I_{(i,j+1)}−I_{(i,j)}|
and pixel intensities in regions where this gradient is sufficiently high are kept while the rest are discarded. This segmentation retains edges of the random speckle pattern and results in significant compression while keeping valuable signal information.

The compressed image is stored in a sparse array format in which each pixel intensity value (I) is combined together with the pixel location (indices i,j) into a single 32-bit word. This reduces the number of memory calls that must be made when correlating. For example, the sample pixel values i=2, j=2, 1=254 is stored as 00000000001000000000001011111110 binary=2,097,918. By masking the bits, the location (i,j) and intensity values (I) can be extracted from this single entry in a few clock cycles of most processors.

Along with the sparse image array, an indices table is generated which contains the location in the sparse image array of the first entry representing a pixel combination in the next line of a speckle image. This line index array is used to jump to the next value of j in the sparse image array when a specified pixel separation is exceeded in the ith direction. When correlating large images, this index array significantly speeds processing.

The reduction in the number of data entries in the speckle image data set by the elimination of pixels in regions with a low intensity gradient and the encoding of the remaining data greatly improves the speed at which correlation windows can be sorted from the data set. In addition, the line index array reduces the number of multiple entries into the sparse image array that must be made to extract the pixels located in a given correlation subwindow. Despite this, window sorting can be a slow memory intensive task that requires considerable processing time.

Correlation window sorting in sparse array format is considerably more difficult than it is in an uncompressed format since the spacing of the data entries is image dependent. A simple block transfer as is commonly done in an uncompressed format cannot be done in the sparse array format. A solution to this is to generate the sparse array at the same time that the correlation windows are being extracted from the image. This technique works well, as long as there is no significant overlap of the correlation windows. If there is significant overlap, the number of redundant memory calls greatly slows processing. The most computationally efficient technique is to pre-sort all of the correlation windows as the sparse array is generated. This technique requires a significant increase in memory storage depending on the overlap in the correlation windows. A 50% overlap results in a four times increase in memory storage. The 32-bit sparse array data encryption scheme, itself, requires four times the number of bits per pixel. Therefore, there is an increase in memory storage requirement by a factor of sixteen. Image compression, however, sufficiently reduces the number of data entries such that there is a net reduction in data storage by roughly a factor of four compared with storing the entire image in memory at one time. In addition, presorting the windows in this manner moves the processing time for window sorting from the basic correlation algorithm into the image-preprocessing algorithm. This allows more time for image correlation within, e.g., a 1/30 of a second video framing speed. Presorting the correlation subwindows at the same time the image is compressed is, therefore, the optimum solution in the majority of applications.

Processing speed can be further increased while, at the same time, reducing the odds of obtaining spurious correlation values by limiting the search for a maximum correlation. This is done by allowing the user to specify a maximum change in Δi and Δj based on knowledge of the image being correlated. An adaptive method can be used to narrow the correlation search—an approach that predicts the range of correlation values to calculate based on previous calculations from subwindows of the same image. This procedure, however, is not particularly robust and can result in spurious errors in obtaining the maximum correlation. Because the sparse array correlation process is inherently very fast, adaptive methods generally do not gain enough processing speed to warrant their use. It is sufficient to set a single value for the correlation range for an entire image.

By using the error correlation function rather than a statistical correlation function, image correlation can be carried out using integer addition and subtraction only. These are very fast operations for most microprocessors requiring only a few clock cycles. It is far faster to perform these calculations than to use a “look-up table” approach to avoid 8-bit or 4-bit pixel multiplication. The use of the error correlation function, therefore, significantly improves processing speed over the more commonly used statistical correlation function. The error correlation function can be expressed as:

$${Φ}_{A , B} ( Δ i , Δ j ) = 1 - \frac{\sum \sum \vert {I}_{m , n}^{( A )} - {I}_{m + Δ i , n + Δ j}^{( B )} \vert}{\sum \sum ( {I}_{m , n}^{( A )} + {I}_{m + Δ i , n + Δ j}^{( B )} )} \qquad ( 4 )$$

The value of the correlation function ranges from 1 when the images are perfectly correlated to 0 when there is no correlation between the images. Because the error correlation function relies on the difference in pixel intensities, it does not unduly weight the significance of high-intensity pixels as does the statistical correlation function. Aside from being faster to calculate than the statistical correlation function, it has the added benefit of being easier to implement in hardware without the need for a microprocessor.

Unlike the more common statistical correlation function, the error correlation function used in sparse array image correlation is not computed one entry at a time. Rather, the entire correlation table is constructed by summing entries as they are found while iterating through the sparse image array. When auto-correlating subwindows, each entry in the sparse image array is compared with the entries below it and a correlation approximation between the entries is added into the correct location in the correlation table based on the difference in i and j between the array entries. If the location is out of range of the specified search length in the ith direction, the entry is ignored and processing continues with the next entry specified in the line index array. If the location is out of range in the jth direction, the entry is ignored and a new series of iterations are made starting with the next sparse image array entry. Because the sparse array is correlated from the top down, only the half of the correlation table representing the positive j direction is calculated. The auto-correlation of an image is symmetrical and thus, calculation of both halves of the correlation table is unnecessary.

Cross-correlation is accomplished by generating two sparse image arrays representing the two images being correlated. The entries of one array are then compared to all of the entries of the other array that are within the search length. Because the difference in array indices can be both positive and negative in the i and j directions, the entire non-symmetrical correlation table is calculated. Once the correlation table is complete, the table is searched for the maximum correlation value. A simple bilinear interpolation scheme is then used to determine the correlation maximum within subpixel resolution. Bilinear interpolation is ideal in this application since reducing the data set by image preprocessing and using the error correlation function results in a very steep, nearly linear, correlation peak.

The computational intensity of sparse array image correlation is comparable to the better known statistical correlation technique except that the image data set is compressed in preprocessing. If the data set is reduced to a fraction, γ, of the original image data set, than the number of data comparisons that must be made is given by

$$\frac{1}{2} γ {Δ}^{2} ( γ {N}^{2} - 1 ) + γ {N}^{2}$$

for sparse array auto-correlation and by γΔ²N² for cross-correlation. For images where the speckle densities are high such that γN²>1 and γΔ²>1 then

$$\frac{1}{2} γ {Δ}^{2} ( γ {N}^{2} - 1 ) + γ {N}^{2}$$

is approximately equal to

$$\frac{1}{2} {γ}^{2} {Δ}^{2} {N}^{2} .$$

A typical speckle data set can be reduced by a factor of 30 such that γ=0.3. Thus, a typical 64×64-pixel correlation subwindow requires a little less than one thousand data comparisons to complete an auto-correlation with a search window of 20×20 pixels. During each comparison, three memory calls are made, one to retrieve a data entry to be compared with the data entry already in the processors register, one to retrieve the value of the correlation table entry, and one to place the comparison result in memory. Memory calls require a great deal more processing time than integer addition and subtraction so that the time for each data entry comparison is essentially the time it takes to make these memory calls. By ordering data entries sequentially when extracting the correlation subwindows from the image data set, very high bus transfer rates can be achieved using block memory transfers.

Unlike other methods that assume oversampling and hence rely on similarity of neighboring measurements, the present error correction approach eliminates false weighting and enhances real correlation through direct element-by-element comparison of the correlation tables calculated from adjacent regions.

A significant or sudden change in depth and locally insufficient speckle density can create false displacement peaks with comparable height exceeding that of the true correlation peak. The latter problem becomes a crucial issue at increasing spatial resolution of disparity detection. Because cross-correlation inherently gives averaged depth information, high spatial resolution (small sub-image window size) is strongly required to reduce this averaging. Furthermore, disparity variation due to depth change across the interrogated sub-image window can result in elongated or even splintered signal peaks on the correlation table, which results in decreased signal-to-noise ratio that can lead to spurious detection.

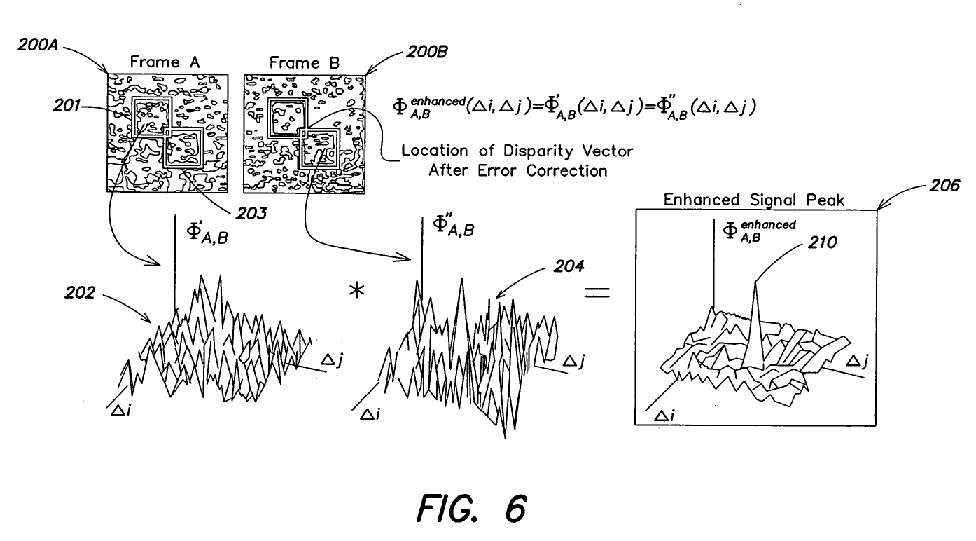

It has been discovered that correlation anomalies and errors due to insufficient data can be eliminated simply by multiplying the correlation tables generated from one or more adjacent regions. This technique is referred to herein as correlation error correction. FIG. 6 shows the effect of correlation error correction applied to images 200A, 200B. Correlation table Φ′ (202) corresponds to cross-correlation of region 201 in the respective frames 200A, 200B. Correlation table Φ″ (204) corresponds to cross-correlation of region 203 in the respective frames 200A, 200B. Using the correlation error correction, a correlation table Φ(enhanced) (206) is produced by the element-by-element multiplication of tables Φ′ and Φ″ as shown in FIG. 6.

As shown in FIG. 6, image disparity that does not correlate equally is minimized while the joint part of the signal peaks is enhanced. In this way not only is the effect of spurious displacements reduced, but the inherent low pass filtering of correlation is also eliminated. The correlation error correction takes place as an automatic enhancement of mutual correlation of differently elongated (due to displacement variation) signal peaks. Hence, the tallest peak 210 of the enhanced correlation table 206 gives localized depth information at very high spatial resolution.

Correlation error correction is effectively a correlation of a correlation. It is not an averaging technique. Any correlated region that does not appear in both correlation tables is eliminated from the resulting table. Since the probability of exactly the same anomalies appearing in another region is very small, correlation anomalies, regardless of their source, are eliminated from the data. Furthermore, spurious results due to insufficient data are eliminated as any peak in one correlation table that does not exist within the other is eliminated. Even if both correlation tables do not contain the information necessary to resolve the correct correlation peak, combined in this manner, the peak is either easily resolved or it becomes evident that neither table contains sufficient data. (This is often the result of a single light point image within the sample area in one exposure and multiple images in another—rare in high density images.) The resulting correlation peak found in the table is weighted to the displacement of the points of light within the overlap of the combined regions as information within this region identically effects the correlation values in both correlation tables. Light point displacements in regions outside the overlap influence the calculated displacement but to an extent that depends on the similarity in displacement. Thus, rather than a reduction in resolution, there is an improvement that depends on the size of the overlap and the gradient of the surface relative to the size of the sample area.

Under extreme conditions, valid correlations may be eliminated if the displacement of the points of light of the combined regions relative to each other is greater than about one light point image diameter. Therefore, it is desirable to maintain a relatively high level of overlap between regions. The level of effectiveness of this technique, however, increases as the size of the overlapped region decreases due to a reduction in the level of shared information. A fifty-percent overlap has been shown to effectively eliminate correlation errors. As most correlation algorithms currently use a fifty-percent overlap, there is virtually no increase in computational requirements to implement this error correction technique. Furthermore, as it requires a simple element by element multiplication between tables, the correlation error correction technique is generally easier and computationally more efficient to implement than it is to conduct post-interrogation error correction.

Once the true signal peak is identified on the correlation table, a three-pixel Gaussian fit in agreement with the Gaussian PSF approximation, or a simple bilinear interpolation approach is used to estimate the center of the correlation peak with sub-pixel resolution. This greatly improves the dynamic range of depth detection and makes high resolution possible, such as shown in FIG. 4C.

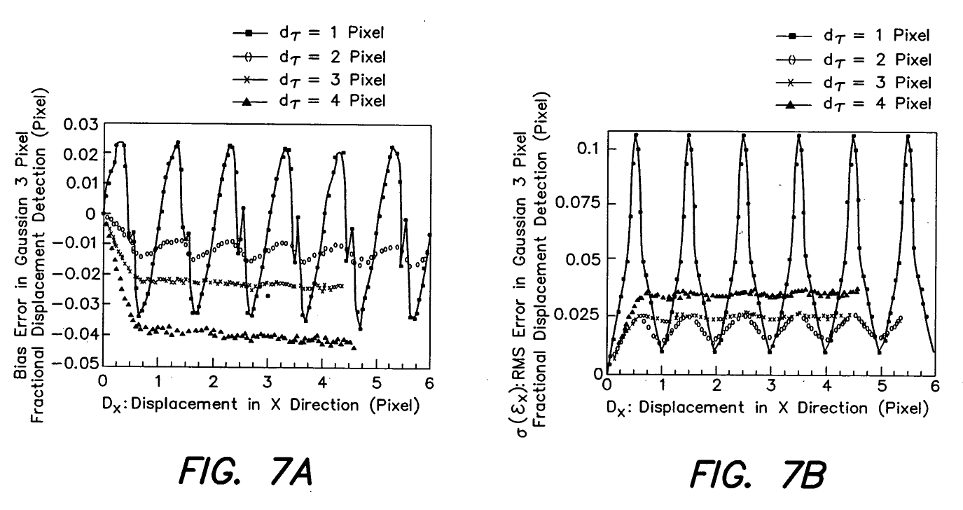

The accuracy in sub-pixel resolution and the uncertainty in identifying the peak center both depend on the speckle parameters (mainly the average speckle diameter) and on the applied processing algorithm. FIGS. 7A, 7B show the respective bias and rms errors of detecting the correlation peak center (by fitting a Gaussian curve on three correlation results around the signal peak) using synthetic speckle images and sub-image cross-correlation. As can be seen, the speckle diameter (d_{τ}) has a strong influence on both the bias and the rms errors, which are the smallest at d_{τ}=2 pixel. Smaller than this optimum speckle size results in strong error fluctuations that bias displacements towards integer values. This “peak-locking” is the result of neglecting signal integration (Gaussian PSF) on the imaging array, which appears to have less influence at larger speckle size. When the peak-fitting algorithm relies only on three correlation values, sub-pixel resolved peak center identification has inherently higher uncertainty at larger speckle diameters than at sharper correlation peaks.

The finite size of sub-image interrogation area results in a negative bias, increasing with image displacement as shown in FIG. 7A, on which the previously mentioned peak-locking is superimposed. This bias can be eliminated either by using a larger second (or first) sub-image window or applying an offset, again, on the second (or first) interrogation area. The latter is implemented in the above described recursive correlation algorithm.

In summary, a high speed three-dimensional imaging system includes a single lens, single camera subsystem having a rotating aperture. The imaging system uses an ultra fast sparse array image cross-correlation algorithm to reveal quantitative 3-D surface information at high spatial resolution. A random speckle pattern projected onto an object is recorded from multiple angles as the off-axis exit pupil rotates along a circle. In this way any out-of-focus object point results in a circular image disparity whose diameter contains the depth information of the point.

Recursive sparse array, compressed image correlation with an original correlation error correction provides for ultra fast processing with spatial resolution set by the resolution limit of the imaging system. Identification of fractional image disparity by a Gaussian PSF approximation increases the dynamic range of displacement detection.

It will be apparent to those of ordinary skill in the art that methods involved in the present invention may be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications or transmission medium, such as a bus or a communications link, either optical, wired, or wireless, having program code segments carried thereon as digital or analog data signals.

While this invention has been particularly shown and described with reference to embodiments thereof, it will be understood by those skilled in the art that various changes in form and details may be made therein without departing from the spirit and scope of the invention as defined by the appended claims.

1. An imaging system for imaging a target in three dimensions, the system comprising:
a light projection source for projecting a beam of light onto the target;
an image acquisition subsystem for acquiring at least two images from light reflected by the target, the image acquisition subsystem comprising a moveable aperture; and
a correlation processor for processing the acquired images according to a sparse array image correlation process.

2. The imaging system of claim 1 wherein the image acquisition subsystem comprises a lens, an aperture element and a camera disposed along an optical axis and wherein the aperture element defines an opening offset from the optical axis and the image acquisition subsystem further includes a rotation means for rotating the aperture element about the optical axis such that the at least two images are acquired sequentially from different angles.

3. The imaging system of claim 1 wherein the image acquisition subsystem comprises a lens, an aperture element and a camera disposed along an optical axis and wherein the camera includes a single CCD element.

4. The imaging system of claim 1 wherein the light projection source includes a diffuser for projecting a beam of light having a random pattern.

5. An imaging method for imaging a target in three dimensions, the method comprising:
projecting a beam of light onto the target;
acquiring at least two images from light reflected by the target through a lens, an aperture element defining a moveable aperture and a camera disposed along an optical axis; and
processing the acquired images according to a sparse array image correlation process.

6. The imaging method of claim 5 wherein the aperture element defines an opening offset from the optical axis and acquiring further includes rotating the aperture element about the optical axis such that the at least two images are acquired sequentially from different angles.

7. The imaging method of claim 5 wherein projecting includes projecting a beam of light having a random pattern.

8. In an imaging system having a lens, an aperture element and a camera disposed along an optical axis, an imaging method for imaging a target in three dimensions, the method comprising:
projecting a beam of light onto the target;
rotating the aperture element such that an opening of the aperture element offset from the optical axis is set to a first position;
acquiring a first image at the camera from light reflected by the target through the lens and the aperture opening at the first position;
rotating the aperture element such than an opening of the aperture element offset from the optical axis is set to a second position;
acquiring a second image at the camera from light reflected by the target through the lens and the aperture opening at the second position; and
processing the acquired images according to an image correlation process to resolve three dimensional components of the target.

9. The imaging method of claim 8 wherein the processing includes processing the acquired images according to a sparse array image correlation process.

10. The imaging method of claim 9 wherein the sparse array image correlation process includes forming first and second image arrays of pixel values from the respective first and second images, each pixel value associated with one of a number of pixels, selecting pixel values in the image arrays which are beyond a pixel threshold value, and performing a correlation process on the selected pixel values comprising creating first and second sparse image arrays of the selected pixel values and their locations in the respective first and second image arrays, performing individual correlations successively between pixel entries of the first sparse image array and pixel entries of the second sparse image array within a pixel distance of each other, and cumulating the correlations in a correlation table at respective distance entries.

11. The imaging method of claim 9 wherein the processing further includes recursive correlation.

12. The imaging method of claim 11 wherein the processing further includes correlation error correction.

13. The imaging method of claim 12 wherein the processing further includes subpixel resolution processing.

14. An imaging system for imaging a target in three dimensions, the system comprising:
a light projection source for projecting a beam of light onto the target;
an image acquisition subsystem for acquiring at least two images from light reflected by the target, the subsystem comprising a lens, an aperture element and a CCD element disposed along an optical axis wherein the aperture element defines an opening offset from the optical axis and the image acquisition subsystem further includes rotation means for rotating the aperture element about the optical axis such that the at least two images are acquired at the CCD element sequentially from different angles; and
a correlation processor for processing the acquired images according to an image correlation process.

15. The imaging system of claim 14 wherein the correlation processor provides processing of the acquired images according to a sparse array image correlation process which comprises forming first and second image arrays of pixel values from respective first and second images, each pixel value associated with one of a number of pixels, selecting pixel values in the image arrays which are beyond a pixel threshold value, and performing a correlation process on the selected pixel values comprising creating first and second sparse image arrays of the selected pixel values and their locations in the respective first and second image arrays, performing individual correlations successively between pixel entries of the first sparse image array and pixel entries of the second sparse image array within a pixel distance of each other, and cumulating the correlations in a correlation table at respective distance entries.

16. The imaging system of claim 14 wherein the correlation processor provides processing that includes recursive correlation.

17. The imaging system of claim 14 wherein the correlation processor provides correlation error correction.

18. The imaging system of claim 14 wherein the correlation processor provides subpixel resolution processing.
